(19) United States
(12) Patent Application Publication
(10) Pub. No.: US 2014/0209828 A1
(43) Pub. Date: Jul. 31, 2014

(54) FLOW CHARACTERIZING DEVICE AND BALL VALVE WITH SUCH A FLOW CHARACTERIZING DEVICE

(71) Applicant: BELIMO HOLDING AG, Hinwil (CH)

(72) Inventors: Ryan WHITMORE, Brookfield, CT (US); Daryl KAUFMAN, Oxford, CT (US); Richard LEDELLAYTNER, Wolcott, CT (US); Chris DEBARBER, Woodbury, CT (US)

(73) Assignee: BELIMO HOLDING AG, Hinwil (CH)

(21) Appl. No.: 13/755,837

(22) Filed: Jan. 31, 2013

(51) Int. Cl. F16K 5/06

(52) U.S. Cl. CPC F16K 5/0605
USPC 251/315.16

(57) ABSTRACT

A flow characterizing device (30) for a valve comprises: a body (31) in form of a disc with a centerline, the body (31) having an inner surface (33) corresponding to the outer surface of the valve member when the flow characterizing device (30) is installed in the flow path of the valve; and an outer surface (37), the inner and outer surfaces (33, 37) of the flow characterizing device (30) disposed in a spaced relationship along the centerline of the flow characterizing device (30). The body (31) of the flow characterizing device (30) further comprises a flow characterizing channel (49) therein extending between the inner surface (33) and the outer surface (37) of the flow characterizing device (30), thereby providing fluid communication between the inner and outer surfaces (33, 37) of the flow characterizing device (30), and defining an opening (32) in the inner surface (33) of the flow characterizing device (30).

To achieve a tight sealing without sacrificing valve operability, the opening (32) of the flow characterizing channel (49) within the inner surface (33) of the flow characterizing device (30) is bordered by a first sealing lip (35), which projects from the inner surface (33) of the flow characterizing device (30) with a predetermined height and width.

### BACKGROUND OF THE INVENTION

The present invention relates to characterized control valves. It refers to a flow characterizing device according to the preamble of claim 1. It further refers to a ball valve with such a flow characterizing device.

### PRIOR ART

Ball valves and plug cock valves are valves which have a movable member (i.e., ball or plug) rotatable, usually 90°, about the movable member's central access to open or close them. Thus, they are generally known as “quarter turn” valves. These valves can be used to control the fluid flow in pipes and in particular in heating, ventilating and air conditioning (HVAC) applications. The ball or plug has a hole that cooperates with a portion of the adjacent valve casing or seat area as the ball or plug is rotated to define a port or fluid flow passageway having an effective cross-section area through which fluid passes.

The relationship between the cross-sectional area of the valve relative to the degree of opening is known as the “valve characteristics”. It is understood that flow characteristics relate to how we operate the valve. The valve characteristics are influenced by the cross-sectional shape of the fluid flow passageway or effective cross-section. An equal change in fluid flow (as a percentage) over the previous flow for each change in the degree of opening of the valve or in shaft rotation is known as “equal percent characteristics”, and is desired in certain applications. For example, if opening the valve by an additional 10% causes a 10% increase in fluid flow, the valve exhibits equal percent characteristics. A valve with equal percent characteristics increases the fluid flow at a very low rate when the valve first begins to open and then as the degree of opening is increased, the rate of increase in fluid flow increases. It is understood by those skilled in the art that equal percent characteristics are theoretical and a goal for valve design

Document U.S. Pat. No. 6,039,304 describes (see also FIG. 1) a ball or plug valve, which is comprised of two pieces and a disk disposed in the seat area having a V-shaped opening with substantially straight side portions, thereby modifying the cross-sectional shape of the port or fluid flow passageway, without unduly increasing the complexity of manufacture or assembly of the valve. As the ball or plug is turned to open the valve, the pointed narrow end of the V-shaped opening is first exposed to the fluid flow. The opposite end from the apex, or the wide end, is exposed to the fluid flow last, as the valve ball or plug approaches its fully-opened position. It should be noted that generally the larger the cross-sectional area of the passageway the greater the flow will be, and the smaller the resistance to flow will be.

In the simplest form of the valve according to the U.S. Pat. No. 6,039,304, there is a slight clearance between the disc and the curvature of the ball. The smaller the clearance is, the better the rangeability will be (the unwanted flow through the clearance will compromise the rangeability of the valve, especially at first, when the valve begins to open. The smaller the unwanted flow, the better the rangeability will be). Typically, the opening in the disc has one pointed narrow end. It is especially important that the clearance is very small at this end. In order to reduce the clearance, the disc can be spring loaded so it presses against the ball.

Document US 2001/0030309 A1 discloses a control valve for controlling fluid flow in industrial systems, such as heating, ventilating and air conditioning systems (HVAC), having a fluid flow passageway with a cross-sectional shape of an opening such that the fluid flow increases exponentially as valve ball or plug is opened and which is relatively simple to manufacturer.

The valve has a movable member, which can be a plug or ball, having a hole, and a casing comprised of main body and a screw in body to form a two-piece valve. The casing has connection ports and defines a valve chamber with a seat for receiving the ball or plug. In one embodiment, the valve is modified slightly to retain a disc which has a specially-shaped opening. The disc is inserted into one of the connection ports, usually the downstream port, of the valve adjacent to the ball or plug. Typically, the disc is fastened by a retaining ring or similar device known by those skilled in the art. O-rings are typically used adjacent to the shaft and seat to prevent fluid from leaking around the shaft. A groove is preferably provided in the seat to receive the retaining ring.

The surface of the disc that faces the ball is concave and substantially corresponds to the spherical surface of the ball or plug inside the valve. The disc is preferably mounted with its concave surface resting on or, more preferably, very close to the ball or plug. Preferably, a space between the disc and ball or plug is left so as to minimize fluid from flowing between the disc and the ball or plug (i.e., by-pass flow) yet so as to avoid interference of the disc with the ball or plug and to allow smooth operation of the prior art valve. Most preferably, the space ranges from about 0.0005 to 0.0015 inches, and more preferably is about 0.001 inches.

Document U.S. Pat. No. 7,111,643 discloses a ball valve comprising a valve housing defining a flow path and a longitudinal axis of the flow path, a valve member mounted in the flow path for selective rotation about an axis of rotation extending through the longitudinal axis of the flow path, the valve member having an outer surface thereof defining a controlling edge which is selectively movable along a path extending substantially transverse to both the longitudinal axis and the axis of rotation between a fully open and a fully closed position of the valve member in the flow path as the valve member is rotated about the rotational axis. A flow characterizing device is attached to the valve housing in the flow path adjacent to the valve member, for modifying fluid flow through the flow path. The flow characterizing device comprises a body, defining a longitudinal centerline of the flow characterizing device that extends substantially coincident with the longitudinal axis of the flow path, and a transverse axis of the flow characterizing device that extends substantially coincident with the path of the controlling edge. The body also defines a datum surface of the flow characterizing device corresponding to the outer surface of the valve member. Inner and outer surfaces of the flow characterizing device are disposed in a spaced relationship along the centerline of the flow characterizing device, the inner surface of the flow characterizing device defining a land surface thereof conforming to a portion of the datum surface and contoured to bear against the outer surface of the valve member for forming a substantially fluid-tight seal between the land surface and the outer surface of the valve member. The inner surface of the flow characterizing device further defines a segmented flow characterizing channel therein bounded at least partially by the land surface and the datum surface and including three or more discrete segments thereof, at least one of which is a through-hole extending through the body for providing fluid communication between the inner and outer surfaces of the flow characterizing device, and the other two of the three or more discrete segments being connected in fluid communication with the through-hole, with each discrete segment opening through the datum surface, and, when the controlling edge of the valve member is aligned therewith, providing a uniquely sized, discrete, flow area at least partially bounded by the datum surface, for controlling a flow of fluid through the flow path.

Within the inner surface of the flow characterizing device a pair of recesses are provided, which are not connected in fluid communication with the flow characterizing channel when the outer surface of the valve member is bearing against the land surface. The recessed areas are provided to reduce the contact area between the outer surface of the valve member and the land surface of the flow characterizing bearing, in order to reduce friction and torque required for positioning the valve member with respect to the characterizing bearing.

However, as the inner surface or land surface of the flow characterizing device is itself used to establish a fluid-tight seal between the land surface and the outer surface of the valve member, there are still conflicting requirements with regard to the sealing effectiveness on one hand and the friction on the other hand.

### SUMMARY OF THE INVENTION

It is an object of the invention, to provide a flow characterizing device for a valve, which avoids the disadvantages of the know devices, and which is designed to minimize the leakage between the device and the valve member for establishing a low flow equal percentage valve characteristic without sacrificing the operability of the valve.

It is another object of the invention to provide a valve, which is easy to manufacture and assemble, is easy to operate and has a low flow equal percentage valve characteristic.

These and other objects are obtained by a flow characterizing device according to claim 1 and a valve according to claim 14.

A flow characterizing device according to the invention is adapted for placement in a flow path adjacent to a movable valve member, for modifying fluid flow through the flow path, where the flow path defines a longitudinal axis thereof and the valve member includes an outer surface thereof having a controlling edge which is selectively movable, along a path extending transverse to the longitudinal axis, between a fully open and a fully closed position of the valve member in the flow path. The flow characterizing device comprises: a body in form of a disc with a centerline, the body having an inner surface corresponding in shape to the outer surface of the valve member; and an outer surface, the inner and outer surfaces of the flow characterizing device disposed in a spaced relationship along the centerline of the flow characterizing device; the body of the flow characterizing device further comprising a flow characterizing channel therein extending between the inner surface and the outer surface of the flow characterizing device, thereby providing fluid communication between the inner and outer surfaces of the flow characterizing device, and defining an opening in the inner surface of the flow characterizing device, the opening of the flow characterizing channel within the inner surface of the flow characterizing device being bordered by a first sealing lip, which projects from the inner surface of the flow characterizing device with a predetermined height and width.

According to an embodiment of the invention the valve member is a ball and the inner surface of the flow characterizing device is spherical.

According to another embodiment of the invention, the valve member is a cylinder and the inner surface of the flow characterizing device is cylindrical.

According to another embodiment of the invention the outer surface of the flow characterizing device is flat.

Specifically, the first sealing lip is integral with the body of the flow characterizing device.

More specifically, the body of the flow characterizing device is made of a plastic, especially an ETFE fluoropolymer resin. An ETFE fluoropolymer resin, which is known under the brand name TEFZEL®, is suitable.

According to a further embodiment of the invention the first sealing lip surrounds the opening of the flow characterizing channel at a predetermined distance from the edge of the opening.

According to another embodiment of the invention the first sealing lip has a cross section profile, which is semicircular at its outer end.

According to just another embodiment of the invention the flow characterizing device further comprises a second sealing lip at the circumference of the body of the flow characterizing device for sealing the body against a valve housing.

Specifically, the second sealing lip is integral with the body of the flow characterizing device.

More specifically, the body of the flow characterizing device is made of a plastic, especially an ETFE fluoropolymer resin. Again, an ETFE fluoropolymer resin, which is known under the brand name TEFZEL®, is suitable.

According to another embodiment of the invention the second sealing lip of the body joins the outer surface and is constituted by a local increase in the outer diameter of the body.

Specifically, a conical transition section is provided between the second sealing lip and the smaller diameter part of the body.

A valve according to the invention comprises: a valve housing defining a flow path and a longitudinal axis of the flow path; a valve member mounted in the flow path for selective rotation about an axis of rotation extending through the longitudinal axis of the flow path, the valve member having an outer surface thereof defining a controlling edge which is selectively movable along a path extending substantially transverse to the longitudinal axis between a fully open and a fully closed position of the valve member in the flow path as the valve member is rotated about the rotational axis. A flow characterizing device is attached to the valve housing in the flow path adjacent to the valve member, for modifying fluid flow through the flow path, the flow characterizing device being configured in accordance with one of the claims 1 to 13.

According to an embodiment of the invention the flow characterizing device is removable attached to the valve housing.

Specifically, the flow characterizing device is attached to the valve housing by means of a retaining ring.

Specifically, the valve member is mounted in the valve housing by means of opposing seats, and the flow characterizing device is attached to the valve housing from outside the seats.

More specifically, the valve housing comprises ports for being connected to a hydraulic system, and the flow characterizing device is attachable to or removable from the valve housing through one of the ports.

According to another embodiment of the invention the flow characterizing device is attached to the valve housing such that it is pressed with its first sealing lip in a sealing fashion against the outer surface of the valve member.

According to a further embodiment of the invention the flow characterizing device comprises a second sealing lip at the circumference of the body of the flow characterizing device for sealing the body against the valve housing, wherein the valve housing is provided with a disc receiving bore concentric with the longitudinal axis for receiving the flow characterizing device, and the flow characterizing device is attached to the valve housing such that it presses with its second sealing lip in a sealing fashion against inner wall of the disc receiving bore.

Especially, the valve is a ball valve.

### BRIEF DESCRIPTION OF THE DRAWINGS

The present invention is now to be explained more closely by means of different embodiments and with reference to the attached drawings.

FIG. 1 shows a longitudinal cross section of a ball valve according to the prior art the flow characterizing disc of which is without special sealing means and may be replaced by a flow characterizing device according to the present application;

FIG. 2 shows a top view of a flow characterizing disc for the ball valve of FIG. 1 according to the prior art;

FIG. 3 shows a cross sectional view of the flow characterizing disc of FIG. 2;

FIG. 4 shows two different perspective views from opposing sides of a flow characterizing device or disc according to an embodiment of the invention;

FIG. 5 shows a magnified top view of the disc of FIG. 4;

FIG. 6 shows a side view of the disc of FIG. 4 (FIG. 6a) and a magnified detail of the outer sealing lip (FIG. 6b);

FIG. 7 shows a cross sectional view of the disc of FIG. 4 (FIG. 7a) and a magnified detail of the inner sealing lip (FIG. 7b); and

FIG. 8 shows a cross sectional view of the flow characterizing device or disc in its position attached to the ball valve (FIG. 8a) and a magnified detail of the sealing action of the inner sealing lip (FIG. 8b; the compression of the sealing lip is not shown).

### DETAILED DESCRIPTION OF DIFFERENT EMBODIMENTS OF THE INVENTION

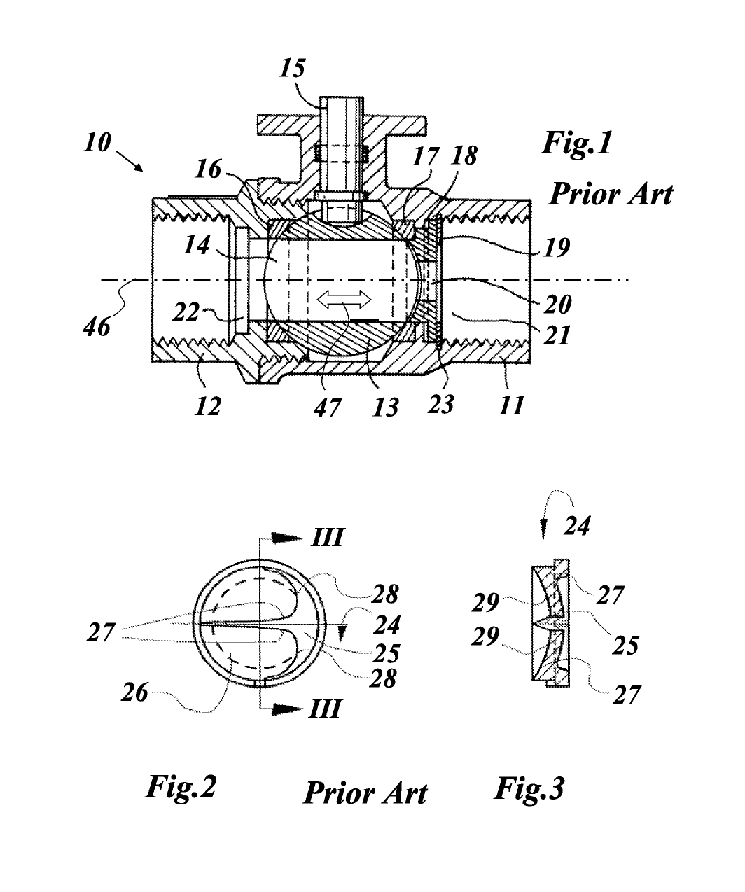

FIG. 1 shows a longitudinal cross section of a ball valve 10 according to the prior art comprising a flow characterizing device or disc 18, which is without special sealing means, and which may be replaced by a flow characterizing device according to the present application. As shown in FIG. 1, the ball valve 10 comprises a valve housing made up of a main body 11 and a screw-in body 12. The valve housing 11, 12 contains a ball 13 with a hole 14, a shaft 15 a downstream seat 16 and upstream seat 17 for the ball 13, the flow characterizing disc 18 with an opening 20, a retaining ring 19 in a groove 23, an upstream port 21 and a downstream port 22.

When assembled together, the main body 11 and the screw-in body 12 form the valve housing or casing, which has connections for the fluid pipe line. The casing has at least two openings connected to a fluid pipe line (not shown) and has an internal cavity which forms a valve chamber with the upstream port 21 and a downstream port 22 for defining a fluid flow path 47 through the chamber. The valve chamber contains the ball 13 and the seats 16 and 17.

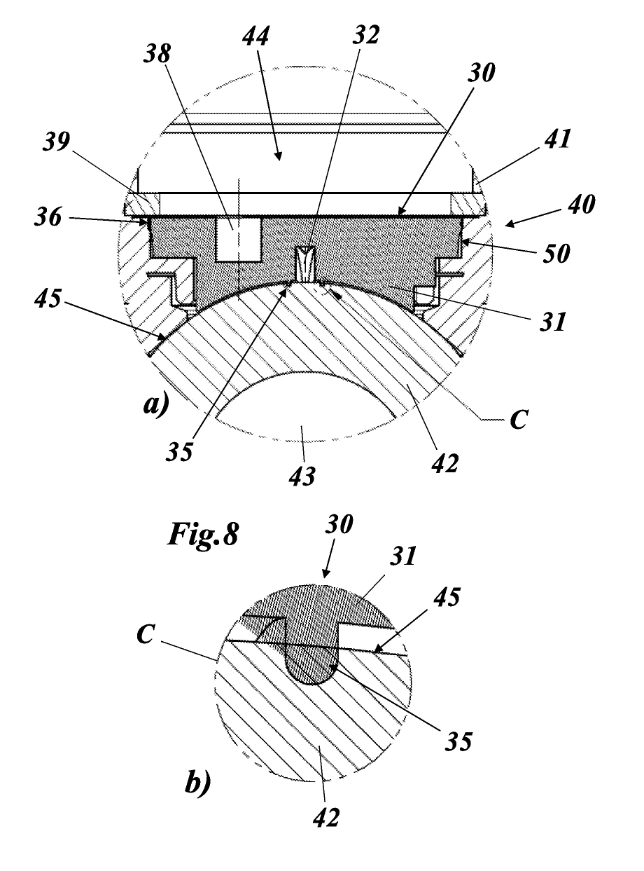

The ball or plug 13 is mounted in the valve chamber and has an exterior or outer surface (45 in FIG. 8) and two ends and a fluid passageway or hole 14 extending between the ends and through the plug 13. The plug 13 also comprises an axis of rotation extending transverse to the longitudinal direction or axis 46 of the fluid flow passageway 14. The plug 13 is rotatable about the axis of rotation for selectively turning the plug 13 between a closed and an open position (shown in FIG. 1), in which the fluid flow passageway 14 is disposed along the fluid flow path of valve 10. In the closed position the passageway 14 is disposed transverse to the fluid flow path 47 of valve 10.

The ball valve 10 of FIG. 1 is a standard ball valve, which has conventional ring-shaped seats 16 and 17 of a resilient material. The direction of flow may be from the upstream port 21 to the downstream port 22. The flow can be reversed, and disc 18 can be mounted and retained at either the upstream port 21 (as shown) or downstream port 22. It is also possible to use two discs, i.e., to mount and retain a disc 18 at both ports.

Disc 18 has an opening 20 therein that is specially shaped to produce a desired flow capacity and flow characteristics. Disc 18 is inserted into the valve 10 and secured therein. One side of the disc 18 is concave with a curvature approximating that of the exterior spherical surface (45 in FIG. 8) of ball 13 (in plug valves this shape is generally semicircular). The disc 18 is (in this case) inserted into the upstream port 21 and secured by a suitable device, such as a retaining ring 19 adjacent to the upstream seat 17 area. The disc 18 fits the inside diameter of the seat 17 as closely as possible, and the concave surface of the disc 18 (see 33 in FIG. 7) follows the spherical curvature of the surface of the ball 13 at a very close distance.

It should be understood that disc 18 is described as concave because it is desired that its exterior surface (33) closely approximates the exterior surface of ball 13. It should be further understood that if the plug took on a different shape, then the disc 18 would take on a corresponding different shape, but nonetheless a shape that closely approximated the shape of the plug.

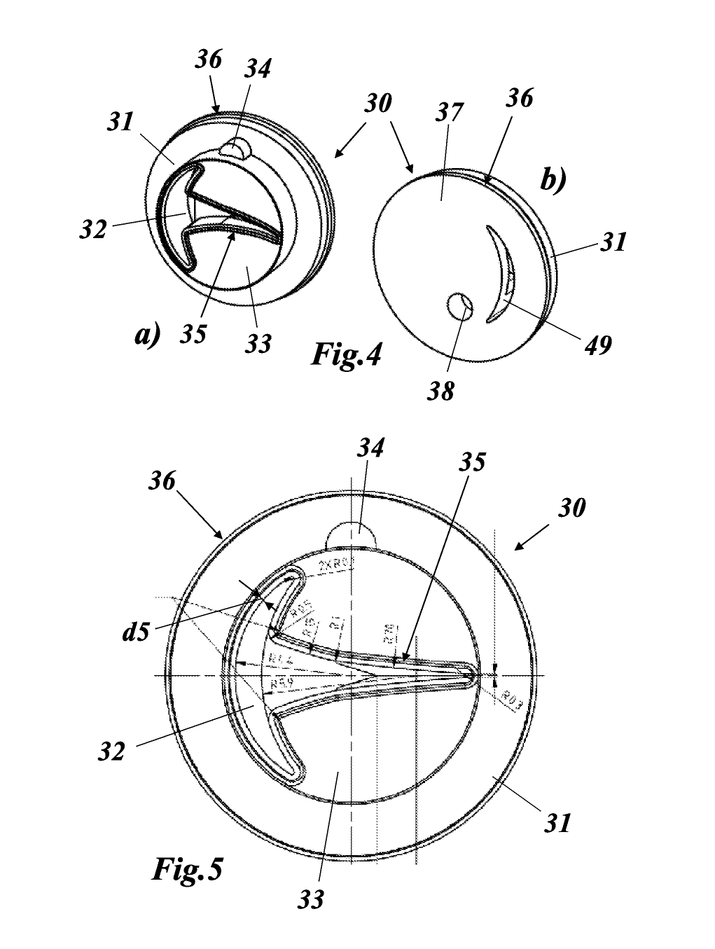

In the disc 18 there is a specially shaped opening 20, which interacts with hole 14 in the ball 13, so the desired flow characteristics is accomplished when the ball 13 is turned between the closed and open positions. The opening 20 may be essentially V-shaped. However, the opening may have an even more sophisticated contour as shown in FIG. 2 or FIG. 5. The opening inside the disc 18 interacts with the fluid passageway extending between the ends of the plug or ball 13 so that different flow characteristics are achieved when the plug 13 is moved between the open and closed positions.

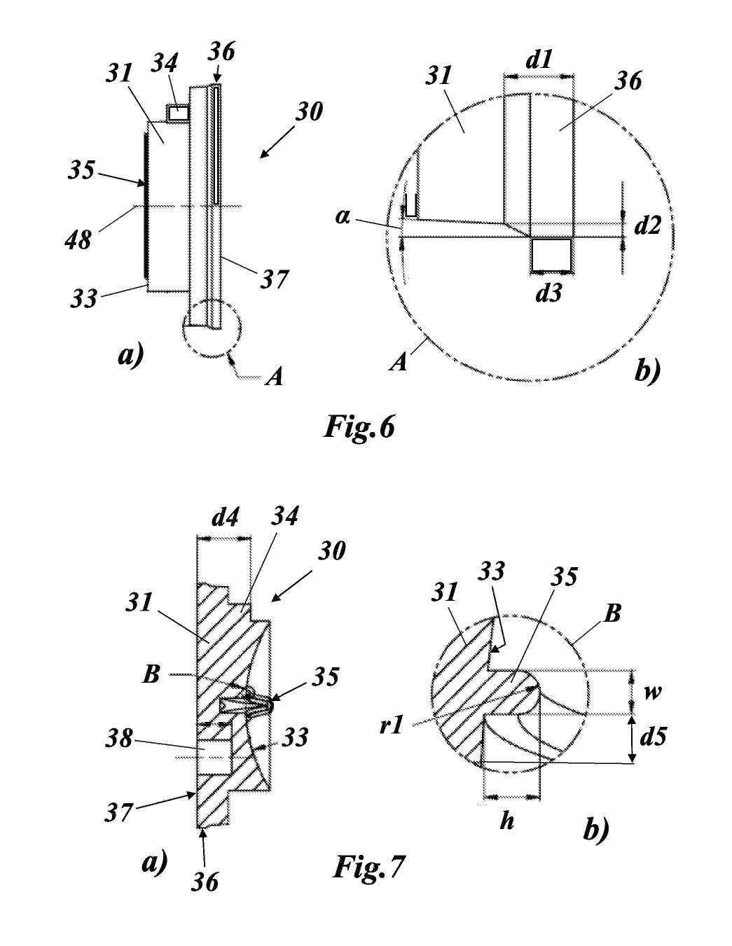

Referring to FIG. 1, near the upstream seat 17 area there is a groove 23 in the main body 11 of valve 10. The groove 14 is sized and shaped to secure the retaining ring 19 in its proper position. Alternatively, it is possible to place the groove 14 in the screw inbody 12. It is important to install the disc 18 in the correct position, so the opening 20 can interact with hole 14 in the ball 13 to accomplish the desired result. This can simply be done by positioning the disc 18 correctly when it is secured by the retaining ring 19. In order to avoid mistakes and positively secure the position of the opening 20 in the disc 18, the disc 18 can be provided with a key (34 in FIG. 6), and the main body 11 is provided with a corresponding recess. The key and the recess determine the position of the disc 18, and thereby the position of the opening 20, so the disc 18 can not be rotated versus the rest of the valve 10. It is of course possible that, instead, the disc 18 has the recess and the main body 11 has the key; other variations would be apparent to those skilled in the art.

Other kinds of openings, which differ from the simple V-shape of opening 20 of FIG. 1, are well-known in the prior art. One example of a disc with an opening of more complex shape or contour is shown in FIGS. 2 and 3. The cross-sectional area of opening 25 of disc 24 has a generally symmetrical shape about a horizontal central axis. The opening 25 has upper and lower portions 27 converging with each other to define an apex or pointed end (on the left side in FIG. 2). Upper and lower sides 27 extend from the apex in a generally curved shape similar to the shape of a cross-section of a trumpet or bell taken along a section line drawn in the longitudinal direction of the trumpet or bell. Portions 27 terminate at ends at the perimeter of the valve chamber. Thus, portions 27 have an outward flared shape. This shape helps to provide an effective cross-sectional area that increases exponentially or escalates as valve 10 approaches its fully opened position, and accordingly approximately equal percent characteristics. It is understood that as long as the cross-sectional area of opening 25 increases in a greater than linear fashion, or preferably exponentially, as the valve approaches its fully opened position, any shaped opening 25 may be used be it holes or other multiple openings.

The generally curved portions 27 are not only flared outward but also back toward the apex terminating at ends on the perimeter of the chamber. These ends are preferably closer to a vertical line drawn through the apex than a point of inflection 28 is relative to the same vertical line. This even further improves the rate of cross-sectional area as the valve 10 is opened. The concave surface 29 of the disc 24 is similar to that of disc 18 in FIG. 1.

In the known ball valve 10 according to FIG. 1, there is a slight clearance between the disc 18 and the curvature of the ball 13. The clearance should preferably be as small as the production tolerances allow. The smaller the clearance is, the better the rangeability will be (the unwanted flow through the clearance will compromise the rangeability of the valve, especially at first, when the valve begins to open; the smaller the unwanted flow, the better the rangeability will be). However, by using a simple curved or concave surface (e.g. 29 in FIG. 3) at the inner side of the flow characterizing disc the clearance is still part of the design thus leading to degradation in the valve characteristics.

To avoid this kind of degradation the present invention teaches to provide the opening of the flow characterizing channel within the inner surface of the flow characterizing device or disc being bordered by a first sealing lip, which projects from the inner surface of the flow characterizing device or disc with a predetermined height and width. With such a sealing lip being provided there is no unwanted flow through the device or disc when the valve is closed so that rangeability of the valve is substantially improved.

An even further improvement of the valve characteristic may be achieved, when the flow characterizing device or disc comprises a second sealing lip at the circumference of the body of the flow characterizing device for sealing the body against the valve housing, whereby advantageously the second sealing lip is integral with the body of the flow characterizing device to simplify the manufacturing and mounting of the device or disc.

FIGS. 4 to 8 show one embodiment of the flow characterizing device or disc according to the present invention. The flow characterizing device or disc 30 of these Figures can for example be used with a ball valve according to FIG. 1.

The flow characterizing device or disc 30 of FIGS. 4 to 8 is adapted for placement in a flow path (47 in FIG. 1) adjacent to a movable valve member 42 (or 13 in FIG. 1), for modifying fluid flow through the flow path 47. The flow characterizing device 30 according to the embodiment comprises a body 31 in form of a disc with a centerline 48 (FIG. 6). The body 31 has an inner surface 33 corresponding to the outer surface (45 in FIG. 8) of the valve member 42 when the flow characterizing device 30 is installed in the flow path 47. It further has an outer surface 37, whereby the inner and outer surfaces 33, 37 are disposed in a spaced relationship along the centerline 48.

The body 31 of the flow characterizing device 30 also comprises a flow characterizing channel 49 (FIG. 4), which extends between the inner surface 33 and the outer surface 37. This flow characterizing channel 49 provides fluid communication between the inner and outer surfaces 33, 37 of the flow characterizing device 30, and defines an opening 32 in the inner surface 33 of the flow characterizing device 30. This opening 32 is bordered by a first sealing lip 35, which projects vertically from the inner surface 33 of the flow characterizing device 30 and has a predetermined height h and width w (FIG. 7).

In the embodiment shown the valve member 42 is a ball; accordingly, the inner surface 33 of the flow characterizing device 30 is spherical. On the other hand, the outer surface 37 of the flow characterizing device 30 is flat. In the outer surface 37 a blind hole 38 is provided in an eccentric position to receive a tool for rotating the disc 30 during mounting in order to bring a key 34 (FIG. 4) on the disc 30 in coincidence with a respective recess in the valve body.

The body 31 of the flow characterizing device 30 is preferably made of an ETFE fluoropolymer resin. A suitable ETFE fluoropolymer resin material is produced by company DuPont and is known under the brand name TEFZEL®. When the body 31 is made of such a material, the first sealing lip 35 can be made integral with the body 31 of the flow characterizing device 30. The first sealing lip 35 completely surrounds the opening 32 of the flow characterizing channel 49, and has a predetermined distance d5 from the edge of the opening 32 to avoid a direct exposure of the lip to the fluid flow. Furthermore, the first sealing lip 35 has a cross section profile with a constant thickness over most of its height and a semicircular contour at its outer end (FIG. 7b).

When mounted in the valve the disc 30 presses—as shown in FIG. 8—with its first sealing lip 35 against the outer surface 45 of the valve body or ball 42, thereby sealing the opening 32 against the outer surface 45. Due to this sealing action there is no bypass flow through the disc 30, when the valve is in the closed position. However, there is still the possibility of a bypass flow around the disc between the circumference of the disc and the housing of the valve.

In order to suppress such outside bypass flow the flow characterizing device or disc 30 further comprises a second sealing lip 36 at the circumference of the body 31 of the flow characterizing device 30 for sealing the body 31 against a valve housing (11, 12 in FIG. 1). Especially, when the body 31 of the flow characterizing device 30 is made of an ETFE fluoropolymer resin, the second sealing lip 36 may be integral with the body 31 of the flow characterizing device 30.

As shown especially in FIG. 6, the second sealing lip 36 of the body 31 joins the outer surface 37 and is constituted by a local increase in the outer diameter of the body 31 (2×d2 in FIG. 6b). To alleviate the mounting of the disc 30 by a self-centering feature, a conical transition section is provided between the second sealing lip 36 and the smaller diameter part of the body 31. In addition, the smaller diameter part of the body 31 itself may have its own conus angle “alpha” (FIG. 6b).

### EXAMPLE

For a ball valve with nominal bore ½″ (DN15) the disc 30 according to the embodiment shown in FIGS. 4-8 has the following dimensions (mm):

| | |
|---|---|
| d1 (distance between outer surface 37 and end of the | 0.8 |
| conical transition section) | |
| d2 (half the local increase in the outer diameter of the | 0.2 |
| body 31) | |
| d3 (height of the second sealing lip 36) | 0.5 |
| d4 (distance between outer surface 37 and inner end of | 3.1 |
| key 34) | |
| d5 (distance of first sealing lip 35 from edge of | 0.2 |
| opening 32) | |
| w (width of first sealing lip 35) | 0.2 |
| h (height of first sealing lip 35) | 0.26 |
| alpha (conus angle of disc body 31) | 3° |

### LIST OF REFERENCE NUMERALS

10 ball valve
11 main body
12 screw-in body
13 ball
14 hole
15 shaft
16 downstream seat
17 upstream seat
18 disc
19 retaining ring
20 opening
21 upstream port
22 downstream port
23 groove
24 disc
25 opening
26 reduced size port
27 lower portions
28 point of inflection
29 concave surface
30 disc
31 body
32 opening
33 inner or bottom surface (spherical)
34 key
35 spherical surface sealing lip
36 outer diameter sealing lip
37 outer surface
38 blind hole
39 retaining ring
40 ball valve
41 valve body
42 ball
43 hole
44 port
45 outer surface (valve body)
46 longitudinal axis
47 flow path
48 centerline
49 flow characterizing channel
50 disc receiving bore
h height (inner sealing lip)
w width (inner sealing lip)

1. A flow characterizing device (30), adapted for placement in a flow path (47) adjacent to a movable valve member (13, 42), for modifying fluid flow through the flow path (47), where the flow path (47) defines a longitudinal axis (46) thereof and the valve member (42) includes an outer surface (45) thereof having a controlling edge which is selectively movable, along a path extending transverse to the longitudinal axis (46), between a fully open and a fully closed position of the valve member (42) in the flow path (47), the flow characterizing device (30) comprising:
a body (31) in form of a disc with a centerline (48), the body (31) having an inner surface (33) corresponding in shape to the outer surface (45) of the valve member (13, 42);
and an outer surface (37), the inner and outer surfaces (33, 37) of the flow characterizing device (30) disposed in a spaced relationship along the centerline (48) of the flow characterizing device (30);
the body (31) of the flow characterizing device (30) further comprising a flow characterizing channel (49) therein extending between the inner surface (33) and the outer surface (37) of the flow characterizing device (30), thereby providing fluid communication between the inner and outer surfaces (33, 37) of the flow characterizing device (30), and defining an opening (32) in the inner surface (33) of the flow characterizing device (30), the opening (32) of the flow characterizing channel (49) within the inner surface (33) of the flow characterizing device (30) being bordered by a first sealing lip (35), which projects from the inner surface (33) of the flow characterizing device (30) with a predetermined height (h) and width (w),
wherein the first sealing lip (35) surrounds the opening (32) of the flow characterizing channel (49) at a predetermined distance (d5) from an edge of the opening (32).

2. The flow characterizing device (30) of claim 1, wherein the valve member is a ball (42) and the inner surface (33) of the flow characterizing device (30) is spherical.

3. (canceled)

4. The flow characterizing device (30) of claim 1, wherein the outer surface (37) of the flow characterizing device (30) is flat.

5. The flow characterizing device (30) of claim 1, wherein the first sealing lip (35) is integral with the body (31) of the flow characterizing device (30).

6. The flow characterizing device (30) of claim 4, wherein the body (31) of the flow characterizing device (30) is made of a plastic.

7. (canceled)

8. The flow characterizing device (30) of claim 1, wherein the first sealing lip (35) has a cross section profile which is semicircular at its outer end.

9. The flow characterizing device (30) of claim 1, further comprising a second sealing lip (36) at the circumference of the body (31) of the flow characterizing device (30) for sealing the body (31) against a valve housing (11, 12).

10. The flow characterizing device (30) of claim 9, wherein the second sealing lip (36) is integral with the body (31) of the flow characterizing device (30).

11. The flow characterizing device (30) of claim 10, wherein the body (31) of the flow characterizing device (30) is made of a plastic.

12. The flow characterizing device (30) of claim 10, wherein the second sealing lip (36) of the body (31) joins the outer surface (37) and is constituted by a local increase in the outer diameter of the body (31).

13. A flow characterizing device (30), adapted for placement in a flow path (47) adjacent to a movable valve member (13, 42), for modifying fluid flow through the flow path (47), where the flow path (47) defines a longitudinal axis (46) thereof and the valve member (42) includes an outer surface (45) thereof having a controlling edge which is selectively movable, along a path extending transverse to the longitudinal axis (46), between a fully open and a fully closed position of the valve member (42) in the flow path (47), the flow characterizing device (30) comprising:
a body (31) in form of a disc with a centerline (48), the body (31) having an inner surface (33) corresponding in shape to the outer surface (45) of the valve member (13, 42); and an outer surface (37), the inner and outer surfaces (33, 37) of the flow characterizing device (30) disposed in a spaced relationship along the centerline (48) of the flow characterizing device (30);
the body (31) of the flow characterizing device (30) further comprising a flow characterizing channel (49) therein extending between the inner surface (33) and the outer surface (37) of the flow characterizing device (30), thereby providing fluid communication between the inner and outer surfaces (33, 37) of the flow characterizing device (30), and defining an opening (32) in the inner surface (33) of the flow characterizing device (30),
wherein the opening (32) of the flow characterizing channel (49) within the inner surface (33) of the flow characterizing device (30) is bordered by a first sealing lip (35), which projects from the inner surface (33) of the flow characterizing device (30) with a predetermined height (h) and width (w),
wherein there is a second sealing lip (36) at the circumference of the body (31) of the flow characterizing device (30) for sealing the body (31) against a valve housing (11, 12),
wherein the second sealing lip (36) is integral with the body (31) of the flow characterizing device (30)
wherein the second sealing lip (36) of the body (31) joins the outer surface (37) and is constituted by a local increase in the outer diameter of the body (31), and
wherein a conical transition section is provided between the second sealing lip (36) and the smaller diameter part of the body (31).

14. A valve (10, 40), comprising:
a valve housing (11, 12) defining a flow path (47) and a longitudinal axis (46) of the flow path (47);
a valve member (13, 42) mounted in the flow path (47) for selective rotation about an axis of rotation extending through the longitudinal axis (46) of the flow path (47), the valve member (13, 42) having an outer surface (45) thereof defining a controlling edge which is selectively movable along a path extending substantially transverse to the longitudinal axis (46) between a fully open and a fully closed position of the valve member (13, 42) in the flow path (47) as the valve member (13, 42) is rotated about the rotational axis; and
a flow characterizing device (30) attached to the valve housing (11, 12) in the flow path (47) adjacent to the valve member (13, 42), for modifying fluid flow through the flow path (47),
the flow characterizing device (30) being configured in accordance with claim 1.

15. The valve of claim 14, wherein the flow characterizing device (30) is removably attached to the valve housing (11, 12).

16. The valve of claim 15, wherein the flow characterizing device (30) is attached to the valve housing (11, 12) by means of a retaining ring (19, 39).

17. The valve of claim 15, wherein the valve member (13, 42) is mounted in the valve housing (11, 12) by means of opposing seats (16, 17), and the flow characterizing device (30) is attached to the valve housing (11, 12) from outside the seats (16, 17).

18. The valve of claim 17, wherein the valve housing (11, 12) comprises ports (21, 22, 44) for being connected to a hydraulic system, and the flow characterizing device (30) is attachable to or removable from the valve housing (11, 12) through one of the ports (21, 22, 44).

19. The valve of claim 14, wherein the flow characterizing device (30) is attached to the valve housing (11, 12) such that it is pressed with its first sealing lip (35) in a sealing fashion against the outer surface (45) of the valve member (13, 42).

20. The valve of claim 14, wherein the flow characterizing device (30) comprises a second sealing lip (36) at the circumference of the body (31) of the flow characterizing device (30) for sealing the body (31) against the valve housing (11, 12), wherein the valve housing (11, 12) is provided with a disc receiving bore (50) concentric with the longitudinal axis (46) for receiving the flow characterizing device (30), and the flow characterizing device (30) is attached to the valve housing (11, 12) such that it the second sealing lip (36) of the flow characterization device (30) presses in a sealing fashion against an inner wall of the disc receiving bore (50).

21. The valve of claim 14, wherein said valve is a ball valve (10, 40).

22. The flow characterizing device (30) of claim 6, wherein the plastic is an ETFE fluoropolymer resin.

23. The flow characterizing device (30) of claim 11, wherein the plastic is an ETFE fluoropolymer resin.
